(19) United States
(12) Patent Application Publication
(10) Pub. No.: US 2009/0032273 A1
(43) Pub. Date: Feb. 5, 2009

(54) IMPLEMENT/VEHICLE STEERING CONTROL SYSTEM AND METHOD

(76) Inventor: Klaus Hahn, Manheim (DE)

Correspondence Address: DEERE & COMPANY, ONE JOHN DEERE PLACE, MOLINE, IL, 61265, US

(21) Appl. No.: 12/142,167

(22) Filed: Jun. 19, 2008

(30) Foreign Application Priority Data
Aug. 2, 2007 (DE) 10 2007 036 429.8

(51) Int. Cl. A01B 63/00

(52) U.S. Cl. 172/2

(57) ABSTRACT

A control system controls steering of an implement which is coupled to an agricultural utility vehicle. The control system includes a control unit, a sensor, a hydraulic system on the utility vehicle, an electronically actuatable hydraulic valve, a hydraulic actuator on the implement and a steerable wheel on the implement. A status variable of the utility vehicle or of the implement can be detected with the sensor and transmitted to the control unit. A current operating state of the utility vehicle and/or of the implement is determined by the control unit. The hydraulic valve is connected to the hydraulic system and to the actuator. The hydraulic valve can be actuated as a function of the current operating state of the utility vehicle and/or of the implement in order to block the steering of the wheel with the actuator.

### FIELD OF THE INVENTION

The invention relates to a control system and a method for operating a control system for steering an implement which is coupled to an agricultural utility vehicle.

### BACKGROUND OF THE INVENTION

Tractors include a hydraulic system which generally has a hydraulic pump driven by the internal combustion engine, a hydraulic reservoir and a plurality of further hydraulic components, such as valves, throttles and hydraulic actuators, by way of example. A tractor usually has additional hydraulic valves with which working functions of an implement which can be coupled to the tractor can be actuated. To this extent, working functions of the implement are supplied by the hydraulic system of the tractor. These additional valves are generally actuated electronically. Examples of working functions are lifting or lowering parts of equipment, wherein parts of equipment may be, in particular, furrow cutters, a sowing machine attached in semitrailer fashion to a soil cultivation machine, fields of a soil cultivation machine, folding parts of machines or working depth settings of the machine. The hydraulic system of the tractor could also be used to drive at least one oil motor of the implement, for example the blower of a pneumatic sowing machine.

In particular, lifting and lowering of the implement, which are initiated by the operator, are sometimes unavoidable when the tractor is reversing or turning, in order to avoid damage to the implement and/or to the ground. If heavy machines are coupled as a combination, for example the sowing combination of a circular hoe and a sowing machine, the machine which is attached in semitrailer fashion, the sowing machine, must in certain cases be additionally lifted by means of an additional hydraulic control unit in order to shorten the overall length of the sowing combination. As a result, a smaller degree of pivoting out can be achieved when cornering and/or the centre of gravity of the sowing combination is moved nearer to the tractor, which is beneficial for the requirement of lifting force and in terms of relieving the loading on the front axle of the tractor. Usually, this process is carried out manually by the operator and takes a correspondingly long time. The sowing combination with the lifting mechanism is generally lifted out without activating an additional hydraulic control unit in order to achieve this effect. However, this requires installing a correspondingly heavy front weight on the tractor.

The actuation of the additional hydraulic valves is also included in a sequence controller in a turn space management system. However, it is then a component of a learnable sequence and generally cannot be addressed individually. Furthermore, such actuation of the additional hydraulic valves is associated with time or travel.

A specific application of the abovementioned principles applies to a vehicle combination composed of a tractor and an implement with a trailing steering system or a trailing axle. Such implements or trailers which are in particular attached in semitrailer fashion (also referred to as tandem or tridem axle trailers) have at least one steering axle. Improved turning and reduced wear of the tires can be achieved with the steering axle. The steering axle of such an implement is coupled to a steering cylinder, which operates on a hydraulic basis, and can be actuated by activating a correspondingly arranged stop valve. The stop valve is either switched on so that the steering cylinder assumes a “floating position”, in which the steering axle can steer. If the stop valve is moved into an off position, the steering axle is moved to the straight ahead position and held in this state. Such trailing steering systems have, in particular when travelling quickly and on a slope a lack of straight ahead running properties if the steering of the wheels is not blocked. Even when reversing, the trailing steering systems usually steer in the wrong direction. For this reason, in such travelling situations, the stop valve has to be actuated manually by the operator of the tractor and correspondingly blocked.

As an alternative to manual actuation by means of a stop valve, mechanical hydraulic positive steering systems are known. In these, in addition to the coupling of the implement by means of a drawbar, an additional linkage of the implement is connected to the tractor in an articulated fashion and adapted. By means of this additional linkage an additional master cylinder can be actuated. For this purpose, it is, however, necessary to adapt or adjust the additional linkage individually to the respective utility vehicle implement combination since the implement can in fact be adapted to different utility vehicles. Furthermore, the coupling of the implement to the linkage on a tractor is awkward. Such positive steering systems restrict the maximum achievable drawbar angle so that the vehicle combination has in total a relatively large turning radius. The hydraulic connection in positive steering systems is also more complex and therefore more expensive.

### SUMMARY OF THE INVENTION

Accordingly, an object of this invention is to provide a control system and a method for operating a control system of the afore-mentioned type by means of which the abovementioned problems are overcome.

A further object of the invention is to provide such a control system which steers an implement coupled to an agricultural utility vehicle in different travelling situations with less complication and preferably a greater level of cost effectiveness.

These and other objects are achieved by the present invention, wherein a control system is provided for steering an implement coupled to an agricultural utility vehicle. The control system includes a control unit, at least one sensor, a hydraulic system on the utility vehicle, at least one electronically actuatable hydraulic valve, at least one hydraulic actuator on the implement and at least one steerable wheel on the implement. A status variable of the utility vehicle or of the implement is detected with the sensor and transmitted to the control unit. The current operating state of the utility vehicle and/or of the implement is determined with the control unit. The hydraulic valve is hydraulically operatively connected to the hydraulic system and to the actuator. The hydraulic valve is actuated as a function of the current operating state of the utility vehicle and/or of the implement in order to block the steering of the wheel with the actuator.

According to the invention, it has firstly been recognized that tractors have a separate hydraulic system which is also used for working functions of implements which are adapted to the tractor. At least in this regard, an infrastructure is therefore provided which can also be used for steering at least one steerable wheel on the implement. A control unit, with which a corresponding hydraulic valve can be actuated, therefore has to be correspondingly configured and/or programmed so that the actuator can be actuated as a function of a specifically present operating state of the utility vehicle and/or of the implement in such a way that the steering of the steerable wheel of the implement can be blocked. If an implement is used which is embodied in a comparable way to the abovementioned implement with the steering cylinder and the stop valve, a hydraulic valve which is already present on the tractor (for example an ESCV—Electronic Selective Control Valve) and an associated fast release coupling could also be easily connected to a steering cylinder of the implement. If the control unit is then correspondingly programmed, it is then possible to determine the current operating state of the utility vehicle or of the implement as a function of the status variable of the utility vehicle and/or of the implement which is determined by the at least one sensor, and to actuate the hydraulic valve as a function thereof in order to block the steering of the wheel.

Steering within the sense of the present invention is to be understood in particular as meaning that the orientation of a wheel relative to the implement can be changed. For example, the wheel can basically be blocked or set itself completely free in terms of orientation such as, for example, a trailing wheel, in particular owing to external peripheral conditions such as, for example, an uneven underlying surface.

According to a preferred embodiment, the steering of the steerable wheel can be performed exclusively by the actuator. It is therefore possible for the steerable wheel to be blocked or released in terms of steering exclusively with the at least one actuator. Positive steering with a linkage is therefore not provided.

The steerable wheel is preferably part of a trailer steering axle or of a steering stub axle system or of a fifth wheel steering system. Furthermore, the steerable wheel could be a trailing wheel or of a drawbar jack castor wheel.

With the sensor it is preferably possible to detect a variable which permits determination of the speed, the acceleration, the direction of travel, the currently set steering angle of the utility vehicle, the deviation from a predefined direction of travel, the spatial position of the utility vehicle, the yaw movement or the yaw torque of the utility vehicle, the yaw movement or the yaw torque of the implement, the gradient of the utility vehicle and/or the gradient of the implement. Furthermore, with the sensor it could be possible to detect a variable which permits determination of the rotational speed of an engine shaft or gear shaft, the rotational speed of steerable wheel, the torque which is transmitted by a shaft, the torque which is output by a drive unit, the power or the capacity utilization of a drive unit, the slip of the utility vehicle and/or of the implement with respect to the underlying surface, the quality of the underlying surface, an axle load, the pressure or the volume flow rate or the change in the volume flow rate of a hydraulic fluid, the excursion travel of a cylinder, in particular of a steering cylinder, the force of the implement acting on the utility vehicle, in particular a traction force, a lateral force and/or a supporting force, the travel state and/or the propulsion force of the utility vehicle. Depending on which variable is actually to be detected with a sensor, this sensor is either arranged on the utility vehicle or on the implement, and is specially designed to detect this variable.

Specifically, the actuator could have a single acting or a double acting hydraulic cylinder. The actuator could be embodied as a steering cylinder for a trailer axle. This requires a corresponding design of a steering axle or of a steerable individual wheel suspension of the wheel of the implement.

Quite preferably, the steering of the steerable wheel can be blocked if the utility vehicle is reversing. As a result, a situation in which the steerable wheel is deflected in the “incorrect” direction when reversing is avoided in all cases. Since the blocking of the wheel occurs quasi automatically as a function of the operating state—the engagement of the reverse gear or the reversing—of the utility vehicle or of the implement, it is also impossible for this to be forgotten by an operator of the utility vehicle and a critical situation therefore cannot arise due to inattentiveness of the operator.

According to one preferred embodiment, the steering of the steerable wheel can be blocked if the utility vehicle exceeds a predefined speed, such as, for example, 15 or 20 km/h since at such a speed it is possible to assume that the vehicle combination is on the road and in the operating state of travel. In this context, the vehicle combination is travelling at an increased speed and as a result a free and deflecting movement of steerable wheel of the implement is avoided.

Furthermore it would also be possible to provide that the steering of the steerable wheel can be blocked if a lateral acceleration and/or a lateral force which exceeds a predefined level acts on the utility vehicle and/or on the implement. This could occur, for example, at a high wind speed in the lateral direction against a tall implement, which can also result in deflection of the wheels of the implement if they are not automatically blocked according to the invention.

It is quite particularly preferred for the steering of the steerable wheel to be capable of being blocked if the utility vehicle and/or the implement has a lateral inclination which exceeds a predefined value. This is helpful in particular when travelling on a slope when therefore owing to the downhill slope force acting on the implement, if the steering of the wheel of the implement is not blocked, there is the risk of the implement veering off laterally downhill, and of the driver of the utility vehicle losing control of the vehicle combination.

The implement could be then coupled to the utility vehicle by any conventional device, including such conventional devices such as a hitch, a drawbar jaw, a bayonet coupling or ball coupling, a three-point equipment attachment, a pick-up hitch or a hexapod hitch.

Preferably, the wheel can be actively steered by the actuator. The steering angle which is to be set for the wheel can be calculated by the control unit as a function of the current operating state of the utility vehicle and/or of the implement. In this context it is possible, for example, for the steering angle which is set at a particular time at the utility vehicle to be a significant reference variable for calculating the steering angle which is to be set for the wheel of the implement. The actuator is then correspondingly actuated by the hydraulic valve, as a result of which the steering angle is correspondingly set at the wheel.

The hydraulic valve could be arranged on the utility vehicle or on the implement. If the utility vehicle is embodied in the form of a tractor, the hydraulic valve is expediently arranged in the rear region of the tractor or it is possible to use a hydraulic valve (ESCV) which is arranged there and is used to supply hydraulic functions of implements which can be adapted to the tractor. The requirement for this is that such a hydraulic valve can be actuated electronically by the control unit. Alternatively, the hydraulic valve could be arranged on the implement and be connected to the control unit via a corresponding electrical line connection, for example with a socket on the utility vehicle. In any case, the hydraulic valve is to be connected hydraulically to the hydraulic system of the utility vehicle and to the at least one actuator, which can be achieved, for example, with a hydraulic quick release coupling.

It is particularly preferred for the hydraulic valve to be actuated automatically. Accordingly, the sensor determines continuously or periodically a status variable of the utility vehicle or of the implement, and transmits the variable to the control unit. The control unit always calculates therefrom the current operating state of the utility vehicle and/or of the implement. As a function of this, the actuator is actuated automatically so that an operator of the utility vehicle does not have to actively set or influence the steering and the implement. However, it would also be possible to provide that the actuation of the hydraulic valve can be switched off, for example if an operator of the utility vehicle would like to influence the steering of the steerable wheel of the implement himself manually.

As already indicated the implement could be embodied in the form of a multi axle trailer which is attached in semitrailer fashion, wherein part of the weight of the implement is supported via its coupling element on the implement as a supporting load. In the uncoupled state of the implement, the coupling element is supported against dropping down onto the ground by means of a supporting foot.

The trailer could have a non steerable axle and a steerable axle or two steerable axles or a combination of non steerable and steerable axles. Such a trailer is generally coupled to the utility vehicle by means of a drawbar-trailer/drawbar jaw connection, in which case the at least one axle of the trailer can constitute a steering axle, which axle can be positively steered in the case of a steering axle.

### BRIEF DESCRIPTION OF THE DRAWINGS

FIG. 1 is a schematic side view of an agricultural utility vehicle and implement with a control system of the present invention; and

FIG. 2 is a schematic top view of an agricultural utility vehicle and implement with a control system of the present invention.

### DESCRIPTION OF THE PREFERRED EMBODIMENT

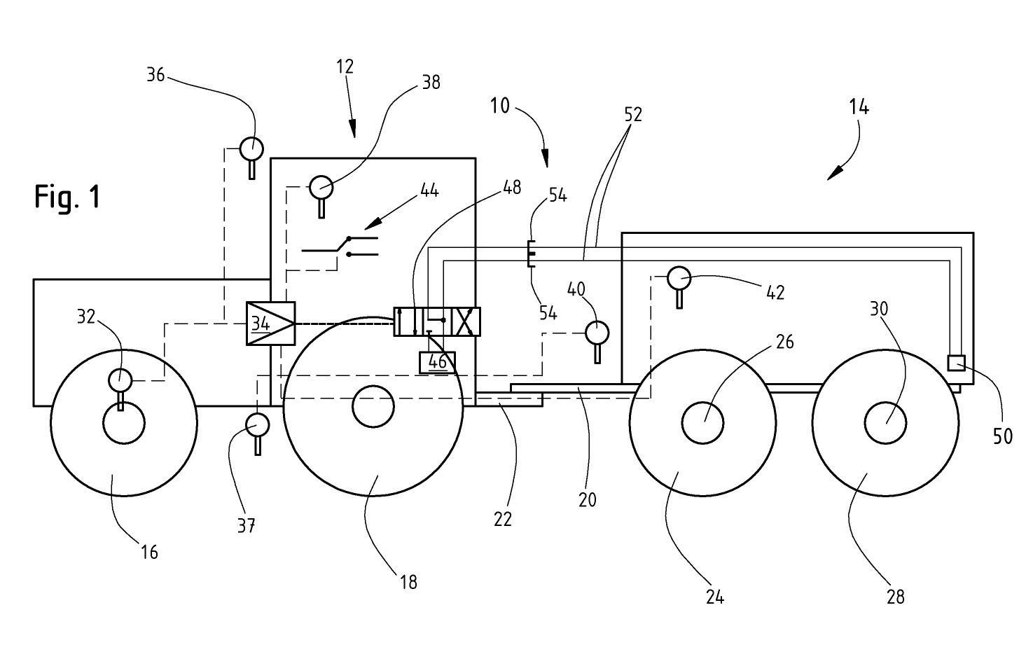

In FIG. 1, a vehicle combination 10 includes an agricultural utility vehicle 12, such as a tractor, and an implement 14. The implement 14 may be a towed trailer. The tractor 12 has two front wheels 16 and two rear wheels 18. The front wheels 16 are steerably coupled to an individual wheel suspension (not shown). The trailer 14 is coupled to a drawbar 12 at the drawbar hitch 22 of the tractor 12. The trailer 14 has front wheels 24 which are rotatably mounted on a front axle 26 which is non steerable. The rear wheels 28 of the trailer 14 are rotatably and steerably mounted on the trailing steering axle 30. The rear wheels 28 are coupled to an individual wheel suspension (not shown) on the chassis of the trailer 14. The implement (14) can be coupled to the utility vehicle by means of a drawbar jaw, a hitch (22), a ball coupling, a bayonet coupling, a three point equipment attachment or a hexapod.

The tractor 12 has a plurality of sensors. It is therefore possible, for example, to detect the steering lock of a front wheel 16 with the steering angle sensor 32. The variable which is determined by the steering angle sensor 32 and which depends on the currently set steering angle of the front wheel 16 is transmitted to the control unit 34 via the electrical line connections. The lateral inclination and longitudinal inclination of the tractor 12 with respect to the horizontal can be detected with the inclination angle sensor 36. The acceleration sensor 38 detects the acceleration of the tractor 12. The speed of locomotion of the tractor 12 relative to the underlying surface can be detected with the speed sensor 37. An acceleration sensor 40 and an inclination angle sensor 42, with which the acceleration or the lateral inclination and longitudinal inclination with respect to the horizontal of the trailer 14 can be respectively detected, are provided on the trailer 14. The variables which are determined by the sensors 36, 38, 40, 42 are also transmitted to the control unit 34 via the line connections. In FIG. 1, the sensors 32, 36, 38, 40, 42 are shown only by way of example, while other and/or further sensors for detecting other variables may be provided. With the direction of travel selector lever 44 it is possible to switch over between forward travel and reverse travel of the tractor 12. The respective state of the direction of travel selector lever 44 is also conveyed to the control unit 34.

The tractor 12 has a hydraulic system 46 (which is only indicated schematically) with which pressurized hydraulic fluid is supplied to hydraulic actuators of the tractor 12 and of the trailer 14. The hydraulic system 46 is hydraulically connected to the hydraulic valve 48. The hydraulic valve 48 can be actuated electronically by the control unit 34, as a function of the current operating state of the tractor 12 and/or of the trailer 14. An actuator 50, such as a hydraulic cylinder, is provided on the trailer 14. The actuator 50 is hydraulically connected via the hydraulic lines 52 to the hydraulic valve 48 and therefore to the hydraulic system 46 of the tractor 12 via the hydraulic quick-release couplings 54. The hydraulic valve 48 has three valve positions. In the active valve position of the hydraulic valve 48 shown in FIG. 1, the actuator 50 is in the floating position. Accordingly, the steering of the rear wheels 28 is not blocked. If the left-hand valve position of the hydraulic valve 48 is moved into the active position, the actuator 50 is deflected in a direction as a result of which the steering of the rear wheels 28 can be blocked. The right-hand valve position of the hydraulic valve 48 is not used for this application.

According to the invention, the control system for steering a trailer 14 which is coupled to the tractor 12 therefore comprises a control unit 34, at least one sensor (for example 32), a hydraulic system 46 on the tractor 12, an electronically actuated hydraulic valve 48, a hydraulic actuator 50 on the trailer 14 and a steerable wheel 28 on the trailer. A variable of the tractor (specifically the steering angle of the front wheel 16) can be detected with the sensor (for example 32) and transmitted to the control unit 34. A status variable of the current operating state of the tractor 12 can be determined with the control unit 34. The hydraulic valve 48 can be operatively connected in a hydraulic fashion to the hydraulic system 46 and to the actuator 50. The hydraulic valve 48 can be actuated as a function of the current operating state of the tractor 12 and/or of the implement 14 in order to block the steering of the wheel 28 with the actuator 50.

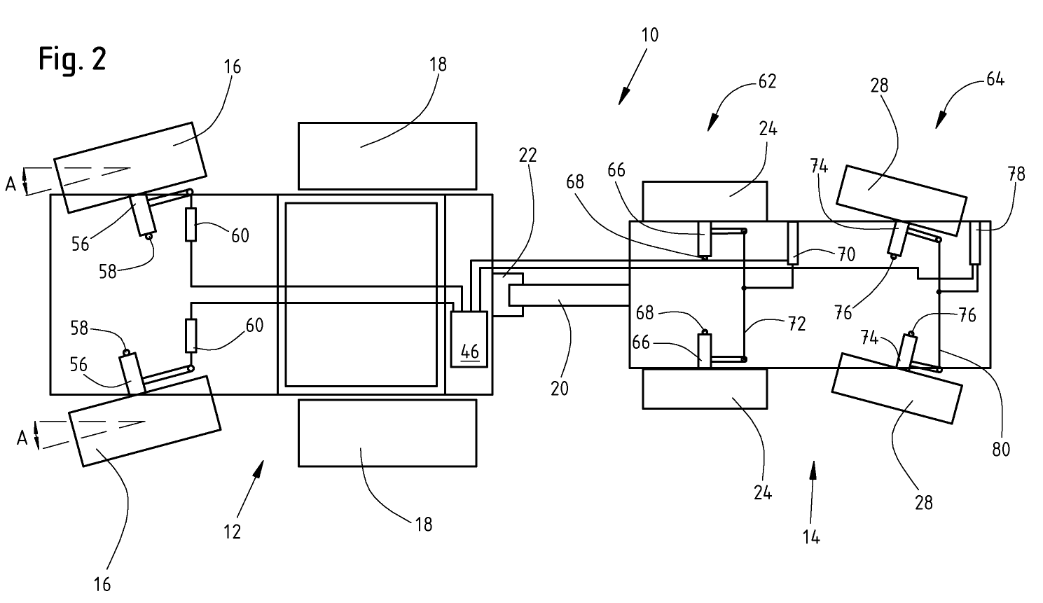

FIG. 2 also shows a vehicle combination 10, including an agricultural utility vehicle such as a tractor 12 and an implement such as a trailer 14. The tractor 12 has two rear wheels 18 and two front wheels 16 which are coupled in a steerable fashion to an individual wheel suspension. The axle stubs 56 bear the front wheels 16 in a rotatable fashion with a further end drive unit (not shown). The axle stubs 56 are mounted so as to be rotatable about an axle 58 which is essentially oriented vertically so that the corresponding steering angle A of the tractor 12 can be set with the steering cylinders 60.

The trailer 14 of FIG. 2 has two steering axles 62, 64. The front wheels 24 and the rear wheels 28 of the trailer 14 are each steerably coupled to an individual wheel suspension. The axle stubs 66 of the front wheels 24 are each mounted so as to be rotatable about the axis 68 of rotation which is essentially oriented vertically. The actuator 70 sets the steering angle lock of the front wheels 24 of the trailer 14 by means of the steering linkage 72. The axle stub 74 of the rear wheels 28 are each mounted so as to be rotatable about the axis 76 of rotation which is essentially oriented vertically. The actuator 78 sets the steering wheel lock of the rear wheels 28 of the trailer 14 by means of the steering linkage 80. The actuators 60, 70 and 78 are connected to the hydraulic system 46 of the tractor 12 by hydraulic lines. The actuators 60, 70 and 78 can each be actuated individually, it being possible to set any desired steering angle of the respective wheel 16, 24 and 28. Correspondingly, separate connecting lines and in each case a separate hydraulic valve are provided for each actuator 60, 70, 78. In particular, the actuators 70, 78 can be used to block the steering of the front wheels 24 and, respectively, of the rear wheels 28 of the trailer 14, for example for travel at a speed of 50 km/h on a road or for reversing in a straight line.

The actuators (50, 70, 78) may be single acting or a double acting hydraulic cylinders.

While the present invention has been described in conjunction with a specific embodiment, it is understood that many alternatives, modifications and variations will be apparent to those skilled in the art in light of the foregoing description. For example, the application of the present invention is not restricted to tractors and agricultural utility vehicles and the application of the present invention would also be conceivable for industrial utility vehicles. Accordingly, this invention is intended to embrace all such alternatives, modifications and variations which fall within the spirit and scope of the appended claims.

I claim:

1. A control system for steering an implement which is coupled to a utility vehicle, comprising:
a control unit;
a sensor;
a vehicle hydraulic system;
an electronically actuatable hydraulic valve;
a hydraulic actuator on the implement; and
a steerable wheel on the implement, wherein the sensor detects a status variable of the utility vehicle or of the implement and transmits a status signal to the control unit, the control unit determining an operating state of the utility vehicle and/or of the implement, wherein the hydraulic valve is connected hydraulically to the hydraulic system and the actuator, and wherein the hydraulic valve can be actuated as a function of the operating state of the utility vehicle and/or of the implement in order to block steering of the wheel with the actuator.

2. The control system of claim 1, wherein:
the steerable wheel is steered exclusively by the actuator.

3. The control system of claim 1, wherein:
the steerable wheel is part of a trailer steering axle.

4. The control system of claim 1, wherein:
the sensor detects at least one variable from a group of variables, including vehicle speed, vehicle acceleration, direction of travel, a currently set vehicle steering angle, a deviation from a predefined direction of travel, a spatial position of the utility vehicle, a vehicle yaw movement, a vehicle yaw torque, an implement yaw movement, an implement yaw torque, a gradient of the utility vehicle and/or a gradient of the implement.

5. The control system of claim 1, wherein with the sensor detects at least one variable from a group of variables, including rotational speed of an engine shaft or gear shaft, a wheel rotational speed, a torque transmitted by a shaft, a torque output of a drive unit, a drive unit power, a drive unit utilization, a vehicle slip, a quality of an underlying surface, axle load, hydraulic the pressure, hydraulic flow rate, steering cylinder travel, a force of the implement acting on the vehicle, a travel state, and/or a vehicle propulsion force.

6. The control system of claim 1, wherein:
the steering of the steerable wheel is blocked if the utility vehicle is reversing.

7. The control system of claim 1, wherein:
the steering of the steerable wheel is blocked if the utility vehicle exceeds a predefined speed.

8. The control system of claim 1, wherein:
the steering of the steerable wheel is blocked if a lateral acceleration and/or a lateral force which exceeds a predefined value acts on the utility vehicle and/or on the implement.

9. The control system of claim 1, wherein:
the steering of the steerable wheel is blocked if the utility vehicle and/or the implement has a lateral inclination which exceeds a predefined value.

10. The control system of claim 1, wherein:
the control unit determines a steering angle for the steerable wheel as a function of a current operating state of the utility vehicle and/or of the implement.

11. The control system of claim 1, wherein:
the hydraulic valve is arranged on the utility vehicle.

12. The control system of claim 1, wherein:
the hydraulic valve is arranged on the implement.

13. The control system of claim 1, wherein:
the hydraulic valve is actuated in an automated fashion.

14. The control system of claim 1, wherein:
actuation of the hydraulic valve can be switched off.

15. The control system of claim 1, wherein:
the implement is a multi axle trailer coupled to the vehicle in semitrailer fashion.

16. In a control system for steering an implement which is coupled to a utility vehicle, the implement having a steerable wheel, the control system having a control unit, a sensor, a vehicle hydraulic system, an electronically actuatable hydraulic valve, a hydraulic actuator on the implement, the hydraulic valve being operatively connected to the hydraulic system and to the actuator, a method of operating comprising:
detecting with the sensor a status variable of the utility vehicle or of the implement;
transmitted the status variable to the control unit;
determining with the control unit a current operating state of the utility vehicle and/or of the implement;
actuating the hydraulic valve as a function of the current operating state in order to block the steering of the steerable wheel with the actuator.
